(19) United States
(12) Patent Application Publication
(10) Pub. No.: US 2024/0384152 A1
(43) Pub. Date: Nov. 21, 2024

(54) SODIUM DECYL- AND LAURYLGLUCOSIDES HYDROXYPROPYL PHOSPHATES AS LUBRICATING AGENTS IN AQUEOUS BASED DRILLING FLUIDS

(71) Applicant: Colonial Chemical, Inc., South Pittsburg, TN (US)

(72) Inventors: Xiangdong Sun, South Pittsburg, TN (US); David Anderson, Jr., South Pittsburg, TN (US); Robert N. Comber, South Pittsburg, TN (US); John W. Baxter, South Pittsburg, TN (US)

(21) Appl. No.: 18/693,135

(22) PCT Filed: Sep. 16, 2022
(86) PCT No.: PCT/US22/43815

§ 371 Date: Mar. 18, 2024

Related U.S. Application Data
(60) Provisional application No. 63/245,127, filed on Sep. 16, 2021.

(51) Int. Cl. C09K 8/08; E21B 21/00; E21B 41/02

(52) U.S. Cl. CPC C09K 8/08; E21B 21/003; E21B 41/02

(57) ABSTRACT

An aqueous based drilling fluid that exhibits improved lubricity, containing a sodium alkylglucosides hydroxypropyl phosphates lubricant component.

### FIELD OF THE INVENTION

The present invention relates to various lubricating agents. Additionally, the present invention relates to methods of improving the lubricity of an aqueous based drilling fluid composed of an aqueous base fluid, and a weighting agent. The method involves the addition of an effective amount of Sodium Decylglucosides Hydroxypropyl Phosphates or Sodium Laurylglucosides Hydroxypropyl Phosphates, or similar phosphate esters, as agents of the present invention to a drilling fluid to substantially reduce the coefficient of friction when compared to the fluid absent the sodium alkylglucosides hydroxypropyl phosphates.

Drilling fluids used in the drilling of subterranean oil and gas wells along with other drilling fluid applications and drilling procedures are known. In rotary drilling there are a variety of functions and characteristics that are expected of drilling fluids, also known as drilling muds, or simply “muds.” The functions of a drilling fluid include, but are not necessarily limited to, cooling and lubricating the bit, lubricating the drill pipe and other downhole equipment, carrying the cuttings and other materials from the hole to the surface, and exerting a hydrostatic pressure against the borehole wall to prevent the flow of fluids from the surrounding formation into the borehole. Drilling muds lubricate both the bearing and cutting surfaces of the drill bit as well as the string of drill pipe both upon rotation and movement along the wellbore horizontally, vertically or any angle. Frequently, in the drilling of wells and especially in directional drilling, the friction between the string of drill pipe and the sides of the borehole may be sufficient to interfere with vertical movement of the pipe into and out of the hole. Such high friction between the drill pipe and the bore hole increases power required to rotate the drill pipe and the increased torque causes wear and stress on the pipe thus decreasing the drilling rate and causing the possibility of pipe twist-off or breakage. The amount of lubricant blend in the drilling fluid can vary, and the amount of lubricant blend in the drilling fluid is effective to increase at least one lubricity property of the water-based drilling fluid as compared to an identical water-based drilling fluid absent the lubricant blend.

Thus, in embodiments of the present invention include compositions that provide lubrication between the equipment and other solid surfaces the equipment encounters. As an example, there is disclosed herein, in one non-limiting form, a water-based drilling fluid that includes water and a lubricant blend of the present invention.

A drilling mud is a mixture of water, clays, and various treating agents which control the physical or rheological properties of the drilling mud in a well bore. In the drilling of a well, the obvious objective is to normally produce hydrocarbons, water, or the like and the drilling mud can serve the function of removing the chips or cuttings, which are produced by the rotating drill bit, from the well bore by circulating drilling mud down from the surface of the well through the drill string and out through openings in the drill bit such that the drilling mud is then circulated upwardly in the annulus between the side of the well bore and the rotating drill string. One of the objectives of a drilling mud is to reduce friction or provide a lubricating medium for the drill bit and the drill pipe to work in while drilling the well bore

Friction is normally defined as a relative resistance to motion of touching surfaces. In the drilling of well bores, friction must be overcome by lubricating and thus enabling the surfaces which are creating undesirable friction to appropriately more or glide over one another.

A drilling fluid is a fluid typically used to aid the drilling of boreholes into the earth. Drilling fluid is used while drilling oil and natural gas wells and on exploration drilling rigs, but is also used for much simpler boreholes, such as water wells. The drilling fluid can be a water-based drilling fluid that includes fresh water, sea water, brine, mixtures of water and water-soluble organic compounds, and mixtures thereof. In some aspects, the drilling fluid also includes a substantial amount of oil. The main function of the drilling fluid is to provide hydrostatic pressure to prevent formation fluids from entering into the well bore, keeping the drill bit cool and clean during drilling, carrying out drill cuttings, and suspending the drill cuttings while drilling is paused. See “The Drilling Fluids Processing Handbook,” by the ASME Shale Shaker Committee, Gulf Professional Publishing (2005), the disclosure of which is incorporated herein by reference.

Various brines, including clear brines are often used in the drilling of subterranean wells during the penetration of the target formation and are often called completion fluids. Brine based drilling muds are also well known to one of skill in the art of drilling. Unfortunately, many if not all the known lubricants useful in aqueous based drilling fluids are not compatible with clear brines or drilling muds that have brine as a major component. Thus, there remains an unmet need for a lubricant for brine-based drilling fluids especially clear brines. Additionally, there remains the need for surfactants that are biodegradable and have high natural content while being effective. The present invention meets that need.

### SUMMARY OF THE INVENTION

Embodiments of the present invention include methods of improving the lubricity of an aqueous based drilling fluids. The methods include improving the lubricity of an aqueous based drilling fluid composed of an aqueous base fluid, and a weighting agent, with the addition of an effective amount of a sodium alkylglucosides hydroxypropyl phosphates agents of the present invention to substantially reduce the coefficient of friction when compared to the fluid absent the sodium alkylglucosides hydroxypropyl phosphates.

Embodiments of the present invention also include aqueous based drilling fluids. An illustrative drilling fluid comprises an aqueous base fluid, a weighting agent, and an effective amount of sodium alkylglucosides hydroxypropyl phosphates of the present invention. The weighting agent can be a water soluble salt selected from at least one of alkali metal halides, alkali metal nitrates; alkali metal sulfates, alkali metal formates; alkali metal acetates, alkali metal propionates, alkaline earth metal halides, alkaline earth metal nitrates; alkaline earth metal sulfates, alkaline earth metal formates; alkaline earth metal acetates, alkaline earth metal propionates, rare earth metal halides, rare earth metal nitrates; rare earth metal sulfates, rare earth metal formates; rare earth metal acetates, rare earth metal propionates, transition metal halides, transition metal nitrates; transition metal sulfates, transition metal formates; transition metal acetates, transition metal propionates, and combinations of these and similar compounds well known to one of skill in the art.

In one embodiment, the sodium alkylglucosides hydroxypropyl phosphates compounds of the present invention, as supplied, have the generalized molecular structure shown in Structure 1, as a mixture:

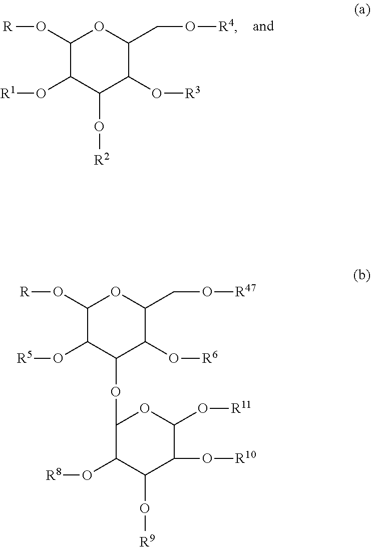

wherein:
R is an alkyl chain having 8 to 22 carbon atoms;
R¹, R², R³, R⁴ R⁵, R⁶, R⁷, R⁸, R⁹, R¹⁰, and R¹¹ are consisting of:

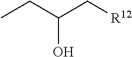

and H, with the proviso that R¹-R¹¹ are not all H;
R¹² is selected from the group consisting of:
   —O—P(O)—(OM)₂ [mono phosphate]
M is a charge balancing group selected from H, Na, K, or NH₄⁺.

The phosphate functionalized sodium alkyl polyglucosides of the present invention also include diphosphate components like those with the following formula:

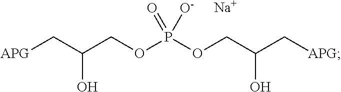

wherein APG is alkyl polyglucoside defined in a) and b) above; and positional isomers thereof. In some embodiments, the alkyl moiety contains about 12 carbon atoms. An example of a suitable phosphate functionalized sodium alkyl polyglucoside includes, but is not limited to, sodium dilaurylglucoside hydroxypropyl phosphate.

Another embodiment of the present invention is sodium hydroxypropylphosphate alkylglucoside crosspolymers, with the generalized molecular structure shown in Structure 2. These surfactants possess a monosaccharide unit, a disaccharide unit, a crosslinking agent, and a phosphate functionalizing agent.

An example of this embodiment is a sodium hydroxypropylphosphate alkylglucoside crosspolymer composition of the following formula, as a mixture:

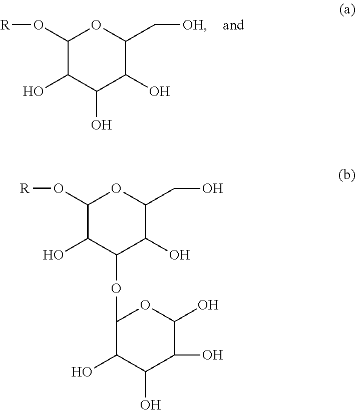

wherein:
R is an alkyl chain having 8 to 22 carbon atoms;
a crosslinking agent; and
a functionalizing agent selected from:
Cl—CH₂—CH(OH)—CH₂—OP(O)—(OM)₂, and combinations thereof, wherein
M is a charge balancing group selected from H, Na, K, or NH₄⁺; and
   and positional isomers thereof.

Crosslinking agents for the polyfunctionalized alkyl polyglucosides described immediately above include, but are not limited to, 1,3-dichloro-2-propanol and epichlorohydrin.

It is recognized that when in formulation the counterions present in the sodium alkylglucosides hydroxypropyl phosphates may exchange with counterions (cations) of other ingredients.

In another embodiment of the present invention, the sodium alkylglucosides hydroxypropyl phosphates compounds of the present invention are sodium alkylglucosides hydroxypropyl phosphates sold by Colonial Chemical, Inc., South Pittsburg, TN; specifically, Suga® Fax D10NC and Suga® Phos 1000 (Sodium Decylglucosides Hydroxypropyl phosphates); and Suga® Fax D-12 and Suga® Phos 1200 (Sodium Laurylglucosides Hydroxypropyl phosphates). In another embodiment of the present invention, the sodium hydroxypropylphosphate alkylglucoside crosspolymers of the present invention are sodium hydroxypropylphosphate alkylglucoside crosspolymers sold by Colonial Chemical, Inc., South Pittsburg, TN; specifically, Poly Suga® Phos 1000P (sodium hydroxypropylphosphate decylglucoside crosspolymer); Poly Suga® Phos 1200P (sodium hydroxypropylphosphate laurylglucoside crosspolymer); and Poly Suga® Phos 8600P (sodium hydroxypropylphosphate cocoglucoside crosspolymer).

Suga® Fax D10NC (CAS: 740817-98-5) is described in U.S. Pat. Nos.: 6,627,612 and 7,045,506.

Suga® Fax D-12 (CAS: 740817-99-6 is described in U.S. Pat. Nos.: 6,627,612 and 7,045,506.

The present invention also includes methods of drilling a subterranean formation utilizing an aqueous based drilling fluid of the present invention. An illustrative drilling fluid of the present invention comprises an aqueous base fluid, with sodium alkylglucosides hydroxypropyl phosphates compound of Structure 1.

The improvement in lubricity is achieved by adding an effective amount of one or more sodium alkylglucosides hydroxypropyl phosphates compounds of the present invention to substantially reduce the coefficient of friction when compared to the fluid absent the sodium alkylglucosides hydroxypropyl phosphates.

In one such illustrative embodiment, the sodium alkylglucosides hydroxypropyl phosphates compounds, have the generalized molecular structure of structure 1 from above (sodium alkylglucosides hydroxypropyl phosphates), wherein: R is a C₈-C₂₂ hydrocarbon group. It is recognized that when in formulation the counterions present in the alkylglucosides hydroxypropyl phosphates may exchange with counterions (cations) of other ingredients.

Further, it should be appreciated that the present invention may also include a brine-based drilling fluid exhibiting increased lubricity as compared to a conventionally formulated drilling fluid. In one embodiment of the present invention, the brine-based drilling fluid includes an aqueous base fluid, composed of an aqueous base fluid, and a weighting agent, with a compound of Structure 1. The water soluble salt selected from alkali metal halides, alkali metal nitrates; alkali metal sulfates, alkali metal formates; alkali metal acetates, alkali metal propionates, alkaline earth metal halides, alkaline earth metal nitrates; alkaline earth metal sulfates, alkaline earth metal formates; alkaline earth metal acetates, alkaline earth metal propionates, rare earth metal halides, rare earth metal nitrates; rare earth metal sulfates, rare earth metal formates; rare earth metal acetates, rare earth metal propionates, transition metal halides, transition metal nitrates; transition metal sulfates, transition metal formates; transition metal acetates, transition metal propionates, and combinations of these and similar compounds. The improved fluid includes an effective amount of one or more sodium alkylglucosides hydroxypropyl phosphates compounds of the present invention, which substantially reduce the coefficient of friction when compared to the fluid absent the sodium alkylglucosides hydroxypropyl phosphates.

Thus, embodiments of the present invention include an improved aqueous, brine-based drilling fluid. Embodiments also include methods of improving the lubricity of an aqueous based drilling fluid. Embodiments also include methods of drilling a subterranean formation utilizing the improved, aqueous, brine-based drilling fluid of the present invention.

### DESCRIPTION OF THE INVENTION

Embodiments of the present invention are directed to a water-base drilling fluid for use in drilling wells. Generally, the drilling fluid of the claimed subject matter may be formulated to include an aqueous continuous phase, a weighting agent and a lubricant/lubricating agent as disclosed herein. The drilling fluids of the claimed subject matter may optionally include additional components, such as viscosity agents, fluid loss control agents, bridging agents, anti-bit balling agents, corrosion inhibition agents, alkali reserve materials and buffering agents, surfactants and suspending agents, rate of penetration enhancing agents and the like that one of skill in the art should understand may be added to an aqueous based drilling fluid.

Embodiments of the present invention are directed to a lubricant/lubricating agent that is compatible with aqueous based drilling fluids, especially brackish water field brines. The lubricant/lubricating agents of the present invention include the sodium alkylglucosides hydroxypropyl phosphates of the current invention.

In embodiments of the invention, the lubricant should be stable up to temperatures of 200° F. and give lubricity values greater than 25% and preferably greater than 35% reduction compared to untreated brines. In addition, the lubricant should exhibit a minimal amount or tendency to grease, “cheese”, foam, or emulsify when added to the brine.

The aqueous based continuous phase may generally be any water-based fluid phase that is compatible with the formulation of a drilling fluid and is compatible with the lubricants disclosed herein. In one preferred embodiment, the aqueous based continuous phase is selected from: fresh water, sea water, brine, mixtures of water and water-soluble organic compounds mixtures of water and water-soluble organic compounds, and mixtures thereof. The amount of the aqueous based continuous phase should be sufficient to form a water-based drilling fluid. This amount may range from nearly 100% of the drilling fluid to less than 30% of the drilling fluid by volume. Preferably, the aqueous based continuous phase is from about 95 to about 30% by volume and preferably from about 90 to about 40% by volume of the drilling fluid.

Drilling fluids are typically classified according to their base fluid. In water-based fluids, solid particles are suspended in a continuous phase of water or brine, or other non-oleaginous fluid, and oil may be optionally emulsified in the water. As used herein, “non-oleaginous” is defined as aqueous substances such as fresh water, seawater, brine containing inorganic or organic dissolved salts, aqueous solutions containing water-miscible organic compounds, and mixtures thereof. In various embodiments of the drilling fluid disclosed herein, the brine may include seawater, aqueous solutions wherein the salt concentration is less than that of sea water, or aqueous solutions wherein the salt concentration is greater than that of seawater. The salinity of seawater may range from about 1 percent to about 4.2 percent salt by weight based on total volume of seawater. Salts that may be found in seawater include, but are not limited to, sodium, calcium, sulfur, aluminum, magnesium, potassium, strontium, lithium, and salts of chlorides, bromides, carbonates, iodides, chlorates, bromates, formates, nitrates, oxides, sulfates, phosphates, silicates and fluorides. Salts that may be incorporated into brine include any of one or more of those present in natural seawater or any other organic or inorganic dissolved salts.

Additionally, brines that may be used in the drilling fluids disclosed herein may be natural or synthetic, with synthetic brines tending to be much simpler in construction. In one embodiment, the density of the drilling fluid may be controlled at least partially by increasing the salt concentration in the brine (up to saturation). In a particular embodiment, a brine may include halide or carboxylate salts of mono- or divalent cations of metals, such as cesium, potassium, calcium, zinc, and/or sodium.

The pH of these solutions is preferably between about 7 to about 12, even more preferably between about 7.5 to about 10.5. The pH can be adjusted by methods known to those skilled in the art, including the addition of bases to the fluids. Such bases include potassium hydroxide, sodium hydroxide, magnesium oxide, calcium hydroxide, and zinc oxide. These aqueous fluids are generally brine solutions . . .

A lubricant of the current invention is included in the formulation of the drilling fluids of the claimed subject matter so that there is substantive reduction in the friction of the drill string. Thus, the lubricant should be present in sufficient concentration to reduce either or both the friction between the drilling string and the walls of the wellbore. The exact amount of the lubricant present in a particular drilling fluid formulation can be determined by a trial-and-error method of testing the combination of drilling fluid and lubricant and the reduction in friction achieved. Generally, however, the lubricant of the claimed subject matter may be used in drilling fluids in a concentration from about 0.01 to about 20 pounds per barrel (lbs/bbl or ppb) and more preferably in a concentration from about 0.1 to about 10 pounds per barrel of drilling fluid.

The drilling fluids of the claimed subject matter include a weight material or weighting agent to increase the density of the fluid. The primary purpose for such weighting materials is to increase the density of the drilling fluid to prevent kickbacks and blowouts. One of skill in the art would understand that the prevention of kickbacks and blowouts is important to the safe day to day operations of a drilling rig. Thus, the weight material is added to the drilling fluid in a functionally effective amount largely dependent on the nature of the formation being drilled. Weight materials suitable for use in the formulation of the drilling fluids of the claimed subject matter may be generally selected from any type of weighting materials be it in a solid particulate form, suspended in solution, dissolved in the aqueous phase as part of the preparation process or added afterward during drilling. In one illustrative embodiment, the weight material may be selected from the group including barite, hematite, iron oxide, calcium carbonate, magnesium carbonate, aqueous soluble organic and inorganic salts, and mixtures and combinations of these compounds and similar such weight materials that may be utilized in the formulation of drilling fluids. The weighting agent is a salt which can be a water soluble salt selected from alkali metal halides, alkali metal nitrates; alkali metal sulfates, alkali metal formates; alkali metal acetates, alkali metal propionates, alkaline earth metal halides, alkaline earth metal nitrates; alkaline earth metal sulfates, alkaline earth metal formates; alkaline earth metal acetates, alkaline earth metal propionates, rare earth metal halides, rare earth metal nitrates; rare earth metal sulfates, rare earth metal formates; rare earth metal acetates, rare earth metal propionates, transition metal halides, transition metal nitrates; transition metal sulfates, transition metal formates; transition metal acetates, transition metal propionates, and combinations of these and similar compounds well known to one of skill in the art.

Additionally, the weighting material may be one described in US Published Patent Application No. 2010/126925. Thus, the weighting material may be for example, galena, hematite, magnetite, iron oxides, illmenite, barite, siderite, celestite, dolomite, calcite, and the like. The quantity of such material added, if any, depends upon the desired density of the final composition. Typically, weight material is added to result in a drilling fluid density of up to about 19 pounds per gallon in one embodiment, and ranging from 9.5 to 14 pounds per gallon in another embodiment.

The drilling fluids of the claimed subject matter can optionally include a viscosifying agent to alter or maintain the rheological properties of the fluid. The primary purpose for such viscosifying agents is to control the viscosity and potential changes in viscosity of the drilling fluid. Viscosity control is particularly important because often a subterranean formation may have a temperature significantly higher than the surface temperature. Thus, a drilling fluid may undergo temperature extremes of nearly freezing temperatures to nearly the boiling temperature of water or higher during its transit from the surface to the drill bit and back. One of skill in the art should know and understand that such changes in temperature can result in significant changes in the rheological properties of fluids. Thus, to control and/or moderate the rheology changes, viscosity agents and rheology control agents may be included in the formulation of the drilling fluid. Viscosifying agents suitable for use in the formulation of the drilling fluids of the claimed subject matter may be generally selected from any type of viscosifying agents suitable for use in aqueous based drilling fluids. In one illustrative embodiment, an optional viscosifying agent is included in the drilling fluid and the viscosifying agent can be selected mixtures and combinations of compounds that should be known to one of skill in the art such as xanthan gums, starches, modified starches and synthetic viscosifiers such as polyarcylamides, and the like.

In addition to the components noted above, the claimed drilling fluids may also be formulated to include materials generically referred to as alkali reserve and alkali buffering agent, gelling materials, thinners, and fluid loss control agents, as well as other compounds and materials which are optionally added to water base drilling fluid formulations. Of these additional materials, each can be added to the formulation in a concentration as rheologically and functionally required by drilling conditions.

One of skill in the art should appreciate that lime is the principal alkali reserve agent utilized in formulating water-based drilling fluids. Alkali buffering agents, such as cyclic organic amines, sterically hindered amines, amides of fatty acids and the like may also be included to serve as a buffer against the loss of the alkali reserve agent. The drilling fluid may also contain anticorrosion agents as well to prevent corrosion of the metal components of the drilling operational equipment. Gelling materials are also often used in aqueous based drilling fluids, and these include bentonite, sepiolite, clay, attapulgite clay, anionic high-molecular weight polymers and biopolymers. Thinners such as lignosulfonates are also often added to water-base drilling fluids. Typically, lignosulfonates, modified lignosulfonates, polyphosphates, and tannins are added. In other embodiments, low molecular weight polyacrylates can also be added as thinners. Thinners are added to a drilling fluid to reduce flow resistance and control gelation tendencies. Other functions performed by thinners include reducing filtration and filter cake thickness, counteracting the effects of salts, minimizing the effects of water on the formations drilled, emulsifying oil in water, and stabilizing mud properties at elevated temperatures.

A variety of fluid loss control agents may be added to the drilling fluids of the claimed subject matter that are generally selected from a group consisting of synthetic organic polymers, biopolymers, and mixtures thereof. The fluid loss control agents such as modified lignite, polymers, modified starches, and modified celluloses may also be added to the water base drilling fluid system of this invention. In one embodiment of the invention, the additives of the invention should be selected to have low toxicity and to be compatible with common anionic drilling fluid additives such as polyanionic carboxymethylcellulose (PAC or CMC), polyacrylates, partially-hydrolyzed polyacrylamides (PHPA), lignosulfonates, xanthan gum, mixtures of these and the like.

Other additives that could be present in the drilling fluids of the claimed subject matter include products such as penetration rate enhancers, defoamers, fluid loss circulation products and so forth. Such compounds should be known to one of ordinary skill in the art of formulating aqueous based drilling fluids.

The drilling fluids of the present invention may be used as described in U.S. Pat. No. 7,094,738, incorporated herein by reference in its entirety.

### EXAMPLES

The following is presented for exemplary purposes only. The Examples and exemplary formulations are not intended to be construed as limiting the present invention.

Testing and Results: Sodium Alkylglucosides hydroxypropyl phosphates of the current invention with structures, depicted above as Structure 1, were evaluated for their ability to improve the lubricity of aqueous based drilling compositions. The Coefficient of Friction (CoF) & Percent Torque Reduction values for fluids containing the sodium alkylglucosides hydroxypropyl phosphates of the invention were determined by incorporating water dispersible drilling lubricants of the current invention in various brine formulations. Standard testing procedures using an OFITE Digital Lubricity Meter (OFI Testing Equipment, Houston, TX) were followed in these studies. This lubricity tester is used to measure the lubricating quality of drilling fluids, provide data to evaluate the type and quantity of lubricating additives that may be required, and predict wear rates of mechanical parts in known fluid systems. The procedure used is designed to simulate the speed of rotation of the drill pipe and the pressure with which the pipe bears against the wall of a bore hole. For the standard lubricity coefficient test, 150 in-lb of torque force (the equivalent of 5,000 to 10,000 psi pressure on the intermediate fluid) is applied to two hardened steel surfaces, a block and a ring rotating ring at 60 rpm. Test concentrations were chosen to be 0.6% by volume of test substance and demonstrate the effectiveness of the sodium alkylglucosides hydroxypropyl phosphates of the present invention at low concentrations. The data in Table 1 was generated using a sodium decylglucosides hydroxypropyl phosphates (Structure 1, where R=10). Sodium Decylglucosides hydroxypropyl phosphates was evaluated at 0.6% by volume, or 0.05 weight % active). Table 1 summarizes both the comparison of coefficient of friction results as well as the torque reduction results for this surfactant in two brine formulations. The percent torque reduction is calculated by comparing the difference between the CoF of decylglucosides hydroxypropyl phosphates in the brine solutions and the CoF of the brine solutions only as a % of the CoF of neat brines.

TABLE 1
Summary of Coefficient of Friction data and Torque
Reduction data for sodium decylglucosides hydroxypropyl
phosphates measured at 72° F. for 5 minutes

| | Brine Only | 0.6% Lubricant A | Torque Reduction |
|---|---|---|---|
| | CoF | CoF | % |
| 10.0 ppg NaCl | 0.313 | 0.194 | 38.02 |
| 10.7 ppg CaCl₂ | 0.164 | 0.084 | 48.8 |
| 9.0 ppg KCl | 0.28 | 0.139 | 50.36 |

As shown above, sodium alkylglucosides hydroxypropyl phosphates of the current invention significantly reduce the coefficient of friction in sodium chloride (38%), calcium chloride (48.8), and potassium chloride (50.36%) drilling or completion fluids. As noted above, results greater than 25% and preferably greater than 35% reduction compared to untreated brines are considered significant for this application. Similar results are expected with other drilling or completion fluids that contain sodium alkylglucosides hydroxypropyl phosphates additives.

As used herein, the singular forms “a,” “an” and “the” include plural referents unless the context clearly dictates otherwise. Thus, for example, reference to “a surfactant” includes mixtures of two or more such surfactants.

It will be apparent to those skilled in the art that various modifications and variations can be made in the present invention without departing from the scope or spirit of the invention. Other aspects of the invention will be apparent to those skilled in the art from consideration of the specification and practice of the invention disclosed herein.

Unless otherwise indicated, all numbers expressing quantities of ingredients, properties such as reaction conditions, and so forth used herein are to be understood as being modified in all instances by the term “about.” Accordingly, unless indicated to the contrary, the numerical parameters set forth in the herein are approximations that may vary depending upon the desired properties sought to be determined by the present invention.

All publications mentioned herein are incorporated herein by reference in their entirety to disclose and describe the methods and/or materials in connection with which the publications are cited.

We claim:

1. Aqueous-based drilling fluids, comprising:
an aqueous base fluid;
a weighting agent; and
a sodium alkylglucosides hydroxypropyl phosphate compound of the following formula: 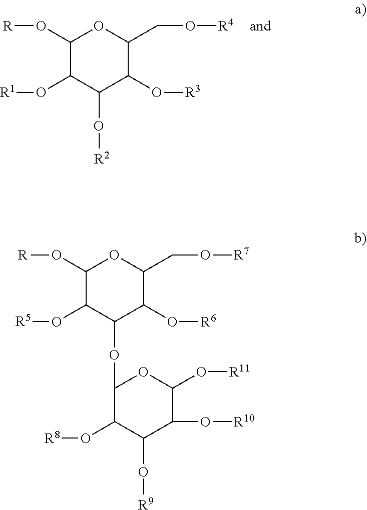
wherein:
R is an alkyl chain having 8 to 22 carbon atoms;
R¹, R², R³, R⁴ R⁵, R⁶, R⁷, R⁸, R⁹, R¹⁰, and R¹¹ are consisting of: 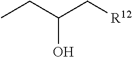
and H, with the proviso that R¹-R¹¹ are not all H;
R¹² is selected from the group consisting of:
—O—P(O)—(OM)₂ [mono phosphate],
where M is a charge balancing group selected from H, Na, K, or NH₄⁺
and wherein when in formulation the counterions present in the sodium alkylglucosides hydroxypropyl phosphates may exchange with counterions of other ingredients; and 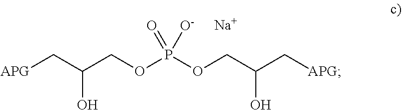
wherein APG is alkyl polyglucoside defined in a) and b) above; and positional isomers thereof.

2. The drilling fluid of claim 1, wherein the weighting agent is a solid weighting agent.

3. The drilling fluid of claim 1, wherein the weighting agent is a water soluble salt selected from at least one of alkali metal halides, alkali metal nitrates; alkali metal sulfates, alkali metal formates; alkali metal acetates, alkali metal propionates, alkaline earth metal halides, alkaline earth metal nitrates; alkaline earth metal sulfates, alkaline earth metal formates; alkaline earth metal acetates, alkaline earth metal propionates, rare earth metal halides, rare earth metal nitrates; rare earth metal sulfates, rare earth metal formates; rare earth metal acetates, rare earth metal propionates, transition metal halides, transition metal nitrates; transition metal sulfates, transition metal formates; transition metal acetates, transition metal propionates, and combinations thereof.

4. The drilling fluid of claim 1, further comprising at least one of a viscosity agent, fluid loss control agent, bridging agent, anti-bit balling agent, corrosion inhibition agent, alkali reserve material buffering agents, surfactants and suspending agent, and/or a rate of penetration enhancing agent.

5. A method of drilling a subterranean formation utilizing an aqueous based drilling fluid, wherein the drilling fluid comprises:
an aqueous base fluid;
a weighting agent;
a sodium alkylglucosides hydroxypropyl phosphates compound of the following formula: 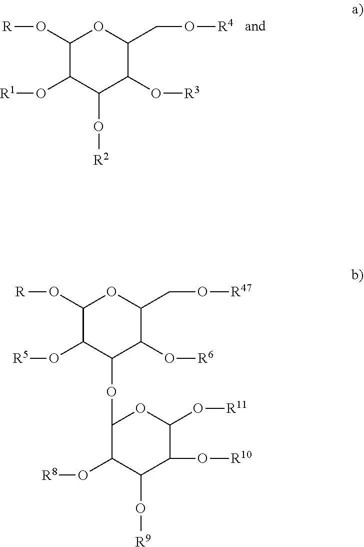
wherein:
R is an alkyl chain having 8 to 22 carbon atoms;
R¹, R², R³, R⁴ R⁵, R⁶, R⁷, R⁸, R⁹, R¹⁰, and R¹¹ are consisting of: 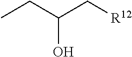
and H, with the proviso that R¹-R¹¹ are not all H;
R¹² is selected from the group consisting of:
—O—P(O)—(OM)₂ [mono phosphate],
where M is a charge balancing group selected from H, Na, K, or NH₄⁺
and wherein when in formulation the counterions present in the sodium alkylglucosides hydroxypropyl phosphates may exchange with counterions of other ingredients; and 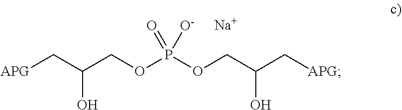
wherein APG is alkyl polyglucoside defined in a) and b) above; and positional isomers thereof.

6. The method of claim 5, wherein the weighting agent is a salt selected from the group consisting of alkali metal halides, alkali metal nitrates; alkali metal sulfates, alkali metal formates; alkali metal acetates, alkali metal propionates, alkaline earth metal halides, alkaline earth metal nitrates; alkaline earth metal sulfates, alkaline earth metal formates; alkaline earth metal acetates, alkaline earth metal propionates, rare earth metal halides, rare earth metal nitrates; rare earth metal sulfates, rare earth metal formates; rare earth metal acetates, rare earth metal propionates, transition metal halides, transition metal nitrates; transition metal sulfates, transition metal formates; transition metal acetates, transition metal propionates, and combinations thereof.

7. The method of claim 5, wherein the drilling fluid further includes a solid weighting agent.

8. The method of claim 5, wherein the drilling fluid further comprises at least one of a viscosity agent, fluid loss control agent, bridging agent, anti-bit balling agent, corrosion inhibition agent, alkali reserve material buffering agents, surfactants and suspending agent, and/or a rate of penetration enhancing agent.

9. An aqueous-based drilling fluid, comprising:
an aqueous base fluid;
a weighting agent; and
a sodium hydroxypropylphosphate alkylglucoside crosspolymer compound of the following formula: 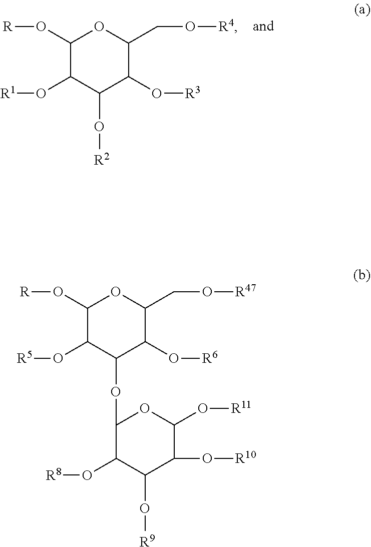
wherein:
R is an alkyl chain having 8 to 22 carbon atoms;
a crosslinking agent; and
a functionalizing agent selected from:
Cl—CH₂—CH(OH)—CH₂—OP(O)—(OM)₂, and combinations thereof, wherein
M is a charge balancing group selected from H, Na, K, or NH₄⁺; and
and positional isomers thereof.

10. The method of claim 9, wherein the crosslinking agent comprises 1,3-dichloro-2-propanol and epichlorohydrin.

11. The drilling fluid of claim 9, wherein the weighting agent is a solid weighting agent.

12. The drilling fluid of claim 1, wherein the weighting agent is a water soluble salt selected from at least one of alkali metal halides, alkali metal nitrates; alkali metal sulfates, alkali metal formates; alkali metal acetates, alkali metal propionates, alkaline earth metal halides, alkaline earth metal nitrates; alkaline earth metal sulfates, alkaline earth metal formates; alkaline earth metal acetates, alkaline earth metal propionates, rare earth metal halides, rare earth metal nitrates; rare earth metal sulfates, rare earth metal formates; rare earth metal acetates, rare earth metal propionates, transition metal halides, transition metal nitrates; transition metal sulfates, transition metal formates; transition metal acetates, transition metal propionates, and combinations thereof.

13. The drilling fluid of claim 9, further comprising at least one of a viscosity agent, fluid loss control agent, bridging agent, anti-bit balling agent, corrosion inhibition agent, alkali reserve material buffering agents, surfactants and suspending agent, and/or a rate of penetration enhancing agent.

14. A method of drilling a subterranean formation utilizing an aqueous based drilling fluid, wherein the drilling fluid comprises:
an aqueous base fluid;
a weighting agent;
a sodium hydroxypropylphosphate alkylglucoside crosspolymer compound of the following formula: 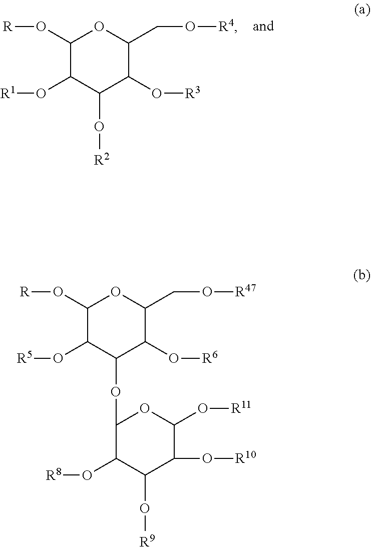
wherein:
R is an alkyl chain having 8 to 22 carbon atoms;
a crosslinking agent; and
a functionalizing agent selected from:
Cl—CH₂—CH(OH)—CH₂—OP(O)—(OM)₂, and combinations thereof, wherein
M is a charge balancing group selected from H, Na, K, or NH₄⁺; and
and positional isomers thereof.

15. The method of claim 14, wherein the crosslinking agent comprises 1,3-dichloro-2-propanol and epichlorohydrin.

16. The method of claim 14, wherein the weighting agent is a salt selected from the group consisting of alkali metal halides, alkali metal nitrates; alkali metal sulfates, alkali metal formates; alkali metal acetates, alkali metal propionates, alkaline earth metal halides, alkaline earth metal nitrates; alkaline earth metal sulfates, alkaline earth metal formates; alkaline earth metal acetates, alkaline earth metal propionates, rare earth metal halides, rare earth metal nitrates; rare earth metal sulfates, rare earth metal formates; rare earth metal acetates, rare earth metal propionates, transition metal halides, transition metal nitrates; transition metal sulfates, transition metal formates; transition metal acetates, transition metal propionates, and combinations thereof.

15. The method of claim 14, wherein the drilling fluid further includes a solid weighting agent.

16. The method of claim 14, wherein the drilling fluid further comprises at least one of a viscosity agent, fluid loss control agent, bridging agent, anti-bit balling agent, corrosion inhibition agent, alkali reserve material buffering agents, surfactants and suspending agent, and/or a rate of penetration enhancing agent.
